(19) United States
(12) Patent Application Publication
(10) Pub. No.: US 2010/0236850 A1
(43) Pub. Date: Sep. 23, 2010

(54) Method and apparatus for adding electric auto function to a gas-driven auto

(76) Inventor: Richard Menelly, Alfred, ME (US)

Correspondence Address: Richard A. Menelly, PO Box 695, Alfred, ME, 04002, US

(21) Appl. No.: 12/381,850

(22) Filed: Mar. 18, 2009

(51) Int. Cl. B60W 10/04; H02P 3/00; B23P 11/00; B60W 20/00

(52) U.S. Cl. 180/65.265; 318/478; 29/428; 903/906

(57) ABSTRACT

The operating shaft of an auto radiator fan is adapted for connection with an electric motor whereby the electric motor rotates the operating shaft, per se, to provide rotation to the auto drive shaft. A control circuit is arranged for connecting the supplemental battery with the electric motor when the auto is driven and disconnecting the supplemental battery from the electric motor when the auto is parked, slowing down and stopping.

### BACKGROUND OF THE INVENTION

Both electric cars and hybrid cars, which combine electric motor function along with the gas-driven engines, are now commercially available.

With the large number of gasoline cars currently owned, it is often difficult to sell the existing gasoline cars to obtain funding for the electric and/or hybrid auto.

Methods currently proposed for converting a gasoline auto to a hybrid auto are both complex and expensive.

One purpose of the instant invention is to describe a simple method for converting a standard gasoline or diesel auto into one that is both electric and gasoline or diesel powered.

### SUMMARY OF THE INVENTION

The operating shaft of an auto radiator fan is adapted for connection with an electric motor whereby the electric motor rotates the operating shaft, per se, to provide rotation to the auto drive shaft. A supplemental electric battery is arranged for providing operating power to the radiator fan-operating shaft or the existing auto battery, per se, can be employed. A control circuit is arranged for connecting the supplemental battery with the electric motor when the auto is driven and disconnecting the supplemental battery from the electric motor when the auto is parked, slowing down and stopping.

### BRIEF DESCRIPTION OF THE DRAWINGS

FIG. 1 is a front perspective view of an automobile hood depicting the automobile exhaust fan arrangement according to the Prior Art;

FIG. 2 is the front perspective view of the automobile hood of FIG. 1 with an electric motor arranged on the exhaust fan drive shaft in accordance with the invention;

FIG. 3 is a front plan view of the automobile trunk at the opposite end of the automobile associated with the automobile hood of FIG. 1 depicting the auxiliary electric battery and control panel associated with the electric motor of FIG. 2;

FIG. 4 is a diagrammatic representation of the control circuit within the control panel of FIG. 3 interconnecting with the battery of FIG. 3 and the electric motor shown in FIG. 2; and

FIG. 5 is the front perspective view of the automobile hood of FIG. 1 with an electric motor arranged on the auto fender in accordance with a further embodiment of the invention;

### DESCRIPTION OF THE PREFERRED EMBODIMENT

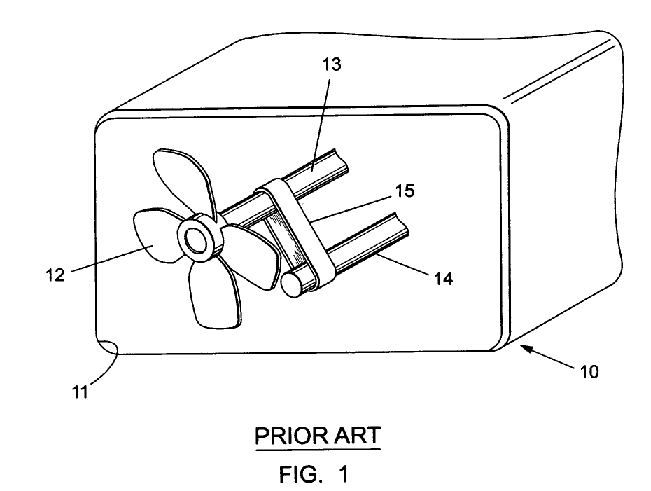

A portion of an auto hood 10 is shown in FIG. 1 with the front part of the radiator enclosure 11 removed to depict the radiator fan 12 supported on a rotating shaft 13 and powered via the propeller drive shaft 14 and fan belt 15 in accordance with the prior art. Although not shown, the radiator fan drive shaft connects with the auto drive shaft for receiving rotational function.

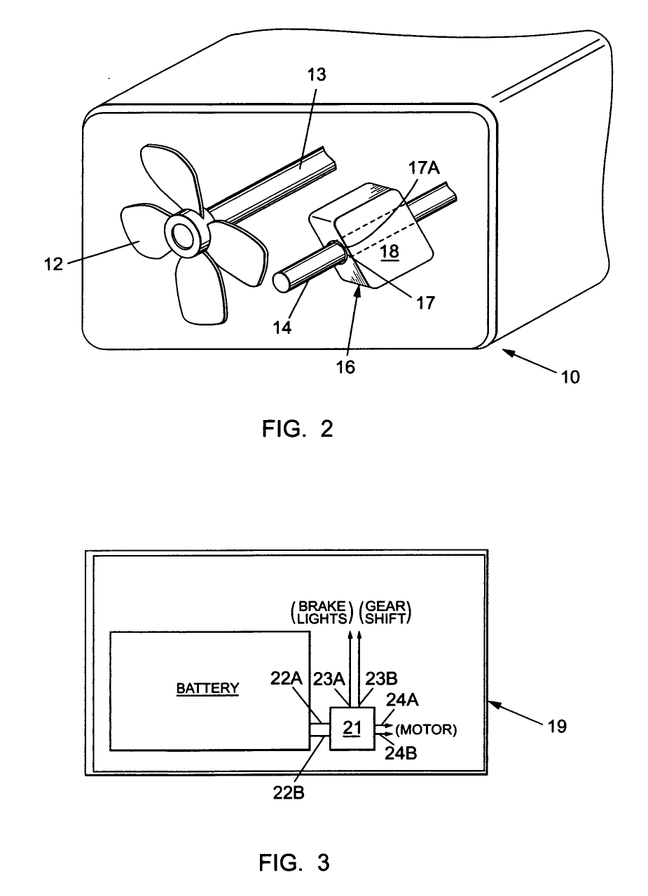

As now shown in FIG. 2, the auto hood 10, with the radiator fan 12 supported on the rotating shaft 13 is depicted with the fan belt 15 (FIG. 1) removed to show the press-fit arrangement of a hollow rotor electric stepper motor 16 on the radiator drive shaft 14 via the opening 17A thru the hollow rotor 17 and stator windings 18. One such stepper motor is an Mdrive 17, which includes a motor controller (not shown) supplied by IMS Inc., Marlborough Conn. “Mdrive” is a trademark owned by IMS inc. for such a motor-driver arrangement.

As now shown in FIG. 3, a large-sized 12 volt auxiliary electric battery 20 such as a type GC-110-Z Deep Cycle sold by Exide Corp. for electric autos, is arranged in the auto trunk 19, with the trunk door (not shown) removed and connects with the logic circuit 21 via conductors 22A, 22B.

To avoid the additional cost of the auxiliary batter 20, the electric stepper motor 16 (FIG. 2) can be connected with the existing auto battery (not shown) that connects with the auto ignition system (not shown).

The logic circuit 21 connects with motor 16 of FIG. 2 via conductors 24A, 24B, and with the auto brake lights and auto gear shift settings, not shown for purposes of clarity, via conductors 23A, 23B.

The connection of the battery 20 and motor 16 (FIG. 2) with the auto brake lights and gearshift settings is an important feature of the invention and will be discussed below in further detail.

The interaction between the electric motor 16 and the auto drive shaft (not shown), which connects with radiator fan drive shaft 14 (FIG. 2), is best seen by now referring to FIGS. 2, 3 and 4.

When operating power is supplied to electric motor 16, a rotational torque is applied to the radiator fan drive shaft 14 which torque is forwarded to the auto drive shaft to assist in the rotation thereof.

The rotational torque reduces the amount of power required to rotate the auto drive shaft so that less energy is required to drive the associated gas or diesel auto engine (not shown) resulting in a savings in fuel required to drive the auto engine, especially when the auto engine is first started.

The control circuit 21 only connects the battery 20 with the motor 16 when the brake lights are off and when the gearshift is in drive to insure that the motor 16 is not supplying rotational torque to the auto drive shaft when the associated auto is slowing down, stopping or parked.

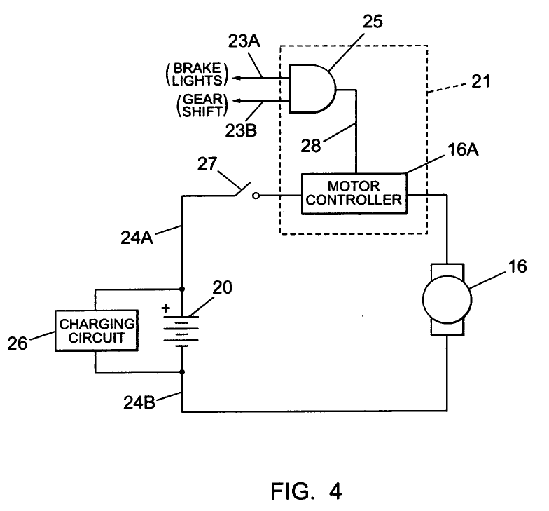

FIG. 4 depicts the electric circuit connecting the battery 20, (FIG. 3) with the electric motor 16 (FIG. 2) via the control circuit 21 of FIG. 2, which operates as follows. Turning on the auto ignition switch 27 connects the battery 20 and charging circuit 26, via conductors 24A, 24B, with the motor controller 16A within the motor 16 to provide the rotational torque to the auto drive shaft as described earlier.

To insure that the motor 16 is not operating when the auto is parked, slowing down or stopping, an OR gate 25 within the control circuit 21 interconnects with the brake lights via input conductor 23A, and with the auto gear shift (not shown) via input conductor 23B. The output of the OR gate connects with the motor controller 16A via output conductor 28 to turn off the motor 16 when current is applied to the brake lights during auto slow down and stoppage as well as when the auto shift (not shown) is in park.

Although the invention relates to gas and diesel fueled autos already in existence, the electric motor 16 shown in FIG. 1 can be used with newly manufactured gas and diesel fueled engines by connecting the auto battery (not shown) that is usually installed for engine starting to the electric motor 16 according to the invention for providing both engine starting function along with electric motor function for further cost savings.

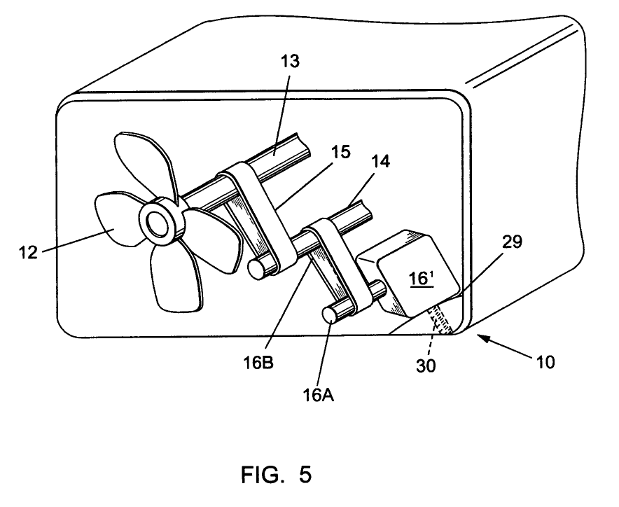

FIG. 5 depicts a portion of an auto hood 10 with the radiator fan 12 supported on the rotating shaft 13 and powered via the radiator drive shaft 14 and fan belt 15 as described earlier.

In order to use the motor 16 of FIG. 1 in accordance with the invention, within autos not having enough room to insert the motor on the radiator propeller drive shaft 14, per se, a motor 16′ such as an IMS M-1713-1.5, having an extending rotor 16′A, is attached to the auto fender 29 via a bolted connector 30 and a separate drive belt 16B is used to connect with and rotate the radiator drive shaft 14 in the same manner as described earlier.

The joint provision of electric power with gas or diesel supplied power has herein been described whereby an electric motor, auxiliary battery and logic circuit can be added to existing gas and diesel autos in a simple and economically feasible manner to provide increased auto performance at reduced fuel costs.

What is claimed is:

1. A means for providing electric motor function to a gas and/or diesel driven auto comprising:
an electric motor arranged for providing rotation torque to a radiator drive shaft and to an auto drive shaft within an associated auto;
a battery arranged for providing operating power to said electric motor when said auto drive shaft is arranged for moving said associated auto; and
means for disconnecting said operating power from said electric motor when said auto drive shaft is arranged for stopping said associated auto.

2. The means for providing electric motor function of claim 1 wherein said means for disconnecting said operating power from said electric motor includes a logic gate.

3. The means for providing electric motor function of claim 2 wherein said logic gate comprises an OR gate connecting with said electric motor and with a brake light and a gear shift within said associated auto.

4. The means for providing electric motor function of claim 1 wherein said electric motor is arranged onto said radiator drive shaft.

5. The means for providing electric motor function of claim 1 wherein said electric motor is attached to a fender on said associated auto.

6. The means for providing electric motor function of claim 5 wherein said electric motor connects with said radiator drive shaft via a drive belt.

7. The means for providing electric motor function of claim 1 wherein said battery comprises an existing auto battery.

8. The means for providing electric motor function of claim 7 wherein said battery comprises an auxiliary battery supplemental to said existing auto battery.

9. A method to install an electric motor within a gas and/or diesel driven auto for assisting said gas or diesel engine comprising the steps of:
arranging an electric motor on an auto radiator drive shaft for providing rotation torque to said radiator drive shaft and thereby to an auto drive shaft;
connecting said electric motor to an electric battery within said associated auto; and
providing means for driving said electric motor when said drive shaft is operational and stopping said electric motor when said drive shaft is non-operational.

10. The method of claim 7 wherein said electric battery is part of an ignition system within said associated auto.

11. The method of claim 7 wherein said electric battery is an auxiliary battery provided within said associated auto.

12. A method to install an electric motor within a gas and/or diesel driven auto for assisting said gas or diesel engine comprising the steps of:
attaching an electric motor to a fender within a motor enclosure for gas or diesel auto;
connecting said electric motor to a radiator drive shaft via a drive belt; and
connecting said electric motor to a battery within said associated auto motor enclosure.

13. The method of claim 12 wherein said battery is an auto battery which is part of an ignition system within said associated auto motor enclosure.

14. The method of claim 10 wherein said battery is an auxiliary battery supplemental to said auto battery

15. The method of claim 12 including the step of:
providing means for driving said electric motor when said drive shaft is operational and stopping said electric motor when said drive shaft is non-operational.
